(19) United States
(12) Patent Application Publication
(10) Pub. No.: US 2003/0149556 A1
(43) Pub. Date: Aug. 7, 2003

(54) Method for modelling and controlling real processes in a data processing equipment and a data processing equipment for carrying out said method

(76) Inventor: Hugo Christian Riess, Icking (DE)

Correspondence Address: KRIEGSMAN & KRIEGSMAN, 665 FRANKLIN STREET, FRAMINGHAM, MA, 01702, US

(21) Appl. No.: 10/204,502

(22) PCT Filed: Feb. 21, 2001
(86) PCT No.: PCT/EP01/01984

(51) Int. Cl. G06F 13/12; G06F 17/60; G06F 13/10; G06F 9/44

(52) U.S. Cl. 703/21; 705/1

(57) ABSTRACT

The invention relates to a method for mathematically simulating and for controlling real flows in a data processing system, comprising the following process steps: establishing and storing a plurality of preset base entities which correspond to real objects, transactions, relations and the like, the base entities having a fixed, constant data structure with preset attributes; establishing and storing preset, permissible relations each between two selected base entities, the relations having a fixed, constant data structure with preset relation attributes; establishing preset standard processes for a preset number of base entities and base relations each of which processes attributes of selected base entities, linked by permissible relations, and base relations for the automatic manipulation of the attribute values of the base entities and base relations, between whose attributes preset, permissible relations are established; allocating of input-status attribute values, which correspond to parameters of the real objects, transactions, relations, etc., to attributes of the base entities and base relations and storing them in these attributes; establishing, storing and allocating rules for the preset standard processes which define how the processes should derive output-status attribute values from the input-status attribute values of the base entities and base relations, said rules comprising a fixed, constant data structure with preset rule attributes.

The invention relates to a method for mathematically simulating and for controlling real flows and application processes in a data processing system and to a data processing system for accomplishing the method.

It is the object of the invention to replace a real process or application process with an equivalent programming-free method which is exclusively individualized by characteristic values of rules.

First, the terms used hereafter will be defined briefly and will be represented in their relationship. Particularly those terms will be explained which are relevant to the classification and understanding of the invention.

A data processing (DP) system comprises data and processes.

The data have a data structure made up of entities (also: characteristic carriers) and attributes (also: characteristics) as well as of the joins between the attributes of these entities. The attributes may take values. These values are also referred to as characteristic values of attributes.

In relational database systems, for example, entities are represented as database tables and attributes are represented as columns of these tables. The characteristic values of all characteristics of a particular entity are stored as a record of this entity. The joins are not necessarily a component of relational databases.

At different times, the data of a DP system may have different values. The totality of the values of all data at a particular time is referred to as the state of the data. The data take a new state whenever a value changes.

Processes are DP processes used to change the state of the data, i.e. the values (characteristic values) of the data are changed by means of processes.

Processes require input data. These input data and the characteristic values permissible for that process are the range of definition for the processes. By means of these input data, the process determines what tasks it has to solve in what way. The result is delivered by the process as output data. The output data and the bandwidth of their possible values describe the range of values for the process. If the values of the output data are such that the previous characteristic values (=values) of the attributes are changed, the process leads to a new state of the data.

The effects of the processes can be described by the way in which they change the state of the data. This can be done by comparing each value of the range of definition with each value of the range of values. In those cases in which the change in the data can be described by algorithms (=rules), the process can also be described by its range of definition and its rules.

However, in any case it is true that the process can be described by the way in which it changes the state of data.

DP systems can be described by the structure of the data, the current data state and by the description of the permissible processes.

DP systems, i.e. the totality of all data and processes, have a particular field of application. The bandwidth of the fields of application can be described by two extreme positions:

1^{st} Category:

The DP system may be designed for exactly one particular requirement, i.e. both the data structure and the processes available have been developed for exactly one particular task. In that case, the entire programming is directed to exactly that requirement. (In general, such a DP system is called a hard-coded system.)

2^{nd} Category:

The DP system may have a very general structure, i.e. the programming covers a wide field of application. In that case, the particular requirement is not solved by a particular programming but by the input of particular parameters or specific rules. These parameters and rules are defined outside of the coded program range in tables or other data stores and are used for controlling the program flows. The respective characteristic values of the parameters and rules then control the generally valid DP system in such a way that it performs exactly with these parameters the specific and special tasks to be currently solved. The essential feature of this solution is the size of the field of application which can be covered by the hard-coded generally valid program in connection with the value ranges of parameters and rules.

The invention is to be classed with the DP systems of the second category and covers a wide field of application.

The present DP system consists of a generic and generally valid data structure and of generic processes and processes which are programmed in a generally valid manner, the general validity relating to a wide field of application which will be described in more detail later.

In addition, the DP system consists of an extensive set of parameters and rules which can be used to adapt this generic, generally valid program to a large number of very specific and special fields of application without the data structure or the programmed processes needing to change.

The fields of application of DP systems differ very much so that they cannot be exactly categorized by the characteristic value of a single characteristic. However, certain categories have become established, such as technical or commercial fields of application. The invention relates to a DP system having a commercial or business field of application. In literature, it would be classed with ERP (Enterprise Resource Planning) systems.

To characterize the field of application in more detail, some business terms will be explained hereafter.

An important field of application of DP systems is the entry, description, administration and control of business functions. These business functions can be broken down into procurement, financing, production and sales and distribution.

Procurement (and, as a special case thereof, financing) deals with the purchase of goods and services, sale (also: marketing, distribution) deals with the sale of goods and services. Procurement and sale are functions whose object is the exchange of activities (briefly: exchange) of goods and services (=products). Production deals with the use of the goods procured and their efficient conversion into new products (goods and services) which in turn are available for sale.

Exchange and production of goods and services (=products) are the major components of business action. The business processes required for the organization of the exchange and production of goods and services (=products) are therefore the relevant object of business DP systems.

Processes for the organization of exchange and production mean all business processes (actions, activities, business orders, operations) required for the organization and performance of exchange and production. According to the history of a business, they can be broken down into processes serving for the introduction, entry, administration and alteration or termination of transactions.

The results of the processes of exchange and production lead to a new state of the data of the DP system. They describe the current products, the state of the agreements (exchange) between the parties to the agreements, the state of the productions and the history of all business processes performed and of the data generated thereby.

In the field of business administration, a distinction can be made between different tasks of, and requirements imposed on, DP systems:

Business data and business processes, when they are divided into the sectors of economy, are to be provided for agriculture, mining, industry and services, trade, banks and insurance companies as well as for public bodies.

Within each sector of economy, very different products (i.e. goods and services) are to be purchased, produced and sold. When, for example, commercial financing as only one segment is taken out of the “banks” sector of economy, here alone a distinction is to be made between the business areas leasing, lease-purchase agreement, real estate leasing, financing of customers (retail financing), marketing financing, dealer financing, wholesale financing, factoring, central regulation, outside financings including loans and purchase of accounts receivable, independent financings through funds and external financings, lendings, EURO funds and time money, etc. In all of these segments, differently specialized methods for entering, processing and outputting information or for supporting the various processes are in use.

When dividing by business functions, the functions and business processes of production planning, purchase, financing, production, marketing and sales and distribution are to be covered.

When dividing by industrial processes, the business data and business processes must be administered or supported in all phases of a business (introduction, entry, administration, alteration and termination of businesses).

When dividing by the categories of cost accounting, the fields of financial accounting, asset accounting, cost accounting, financial statements, cost budgeting, budgeting, target-actual comparisons, contract financial accounting, activity confirmations, accounts receivable and payable accounting, payment transactions, dunning, and the like must be supplied in their business data and business processes with the relevant information and functions.

When dividing by the organizational structure, the employees at all levels must be informed, planned, employed and evaluated.

In all economic and commercial fields of application, there is a very heterogeneous coexistence of differently specialized DP systems because of the multifarious structures.

It is, therefore, the object of the invention to develop a generic DP system which can be used to support all of these requirements imposed on the business data and business processes according to uniform principles and with flexible, specific specializations.

For a large number of existing DP systems (application systems) and DP systems to be newly developed, a method will be described which makes the programming of application processes by means of programming languages unnecessary and instead replaces that programming with the new system.

Instead of programming the processes, the tasks of the processes can be taken over by a generic standard DP system (hereafter referred to as “core”). This object is accomplished by a method having the features of claim 1, 5 or 6.

The invention is based on the principle that an application process can be represented by the set of its actions, i.e. by the way in which it changes the states in the application data, i.e. P={D(t), D(t+1)}. This principle allows application processes to be replaced with standard processes which effect the same changes on the data.

Application data (D) can be transformed into other data (=standard data; SD) without information loss and can be retransformed from the other data (=standard data) as required, i.e.

there is a transformation T with SD(t)=T(D(t)) and

there is a transformation T⁻¹ with D(t)=T⁻¹(SD(t)).

The transformation and retransformation do not result in any loss of information, i.e. D(t)=T⁻¹ T(D(t)).

According to the invention, the standard data have a fixed, unchangeable structure, i.e. fixed entities (base entities) with fixed attributes and fixed relations (base relations) between the attributes, the attributes and relations corresponding to real objects and relationships.

The standard processes process the data on the basis of rules which also comprise a fixed, unchangeable structure with related entities and attributes as well as with fixed relations between their attributes. Only the attribute values of the rules determine how the standard processes should process the characteristic values of the attributes of the standard data (=base entities and relations).

According to the invention, dynamic attributes can be added to each standard entity and each standard entity can be represented in a time-dependent manner.

In a particularly preferred embodiment of the invention, 12 base entities and 11 relations between the base entities are provided. For the mathematical simulation of a general business transaction, the 12 base entities map: total transaction, individual transaction, spreadsheet, activity and its relation to the spreadsheet, agreement, parties and their relation to the agreement, activity object, object, business transaction, scale, time series and posting proposal, as will be explained in more detail later.

For each base entity with its attributes, a generic standard process PA exists for entering, changing and deleting the characteristic values of the attributes.

For each relation between the attributes, a generic standard process PR exists for entering, changing and deleting the characteristic values of the relations.

In addition, according to the invention a process exists which can make up any combinations and sequences of standard processes {PA(i), PR(j)}.

The method according to the invention can be used to simulate the respective tasks of the application processes in three operations (using rules, but without programming):

1. Transformation of each of the application data needed into the data of the standard DP system by allocating the data of the application system (entities, attributes and characteristic values) to the data of the standard system (having fixed entities and attributes and variable characteristic values).

2. Selection of standard processes in the required sequence from a pool of existing standard processes {PA(i), PR(j)} by determining the rules of selection. These rules of selection have a fixed data structure with fixed rule attributes and rule relations and are only defined by variable characteristic values of the rule attributes and rule relations.

3. Determination of the operating mode of the selected standard processes by rules of operation for the standard processes. The rules of operation define what characteristic values the attributes and relations of the standard data should take. The rules of operation have a fixed data structure and are only defined by variable characteristic values of the rule attributes and rule relations.

Therefore, the object of the invention is a standard DP system consisting of an unchangeable data structure and of generic and unchangeable standard processes. By means of rule data having an unchangeable data structure and variable characteristic values, these processes or programs can be selected, arranged and adapted to specific requirements.

The field of application of the method is the DP support of commercial and economic business processes in which products (i.e. goods and services), the exchange of products (procurement, sale), the production, the business processes for the organization of the exchange and production in all phases of history (entry, administration, alteration and termination of exchange and production relations) and the results of these processes are to be presented and controlled.

The advantages of the method according to the invention are that, in the above field of application, it provides the possibility of single and multiple applications of programs at a lower cost and within a shorter time, a common platform for all existing front-end DP systems is created and all back-end systems can be supplied with information from this one platform. Moreover, it allows to construct a universal data warehouse with extensive calculation functions and to minimize the interfaces between the existing front-end and back-end systems. Finally, the invention allows a uniform, standardized and comparable documentation of all available transaction rules from different applications.

The invention will now be explained with greater detail with reference to preferred embodiments thereof which are represented in the accompanying drawings, wherein:

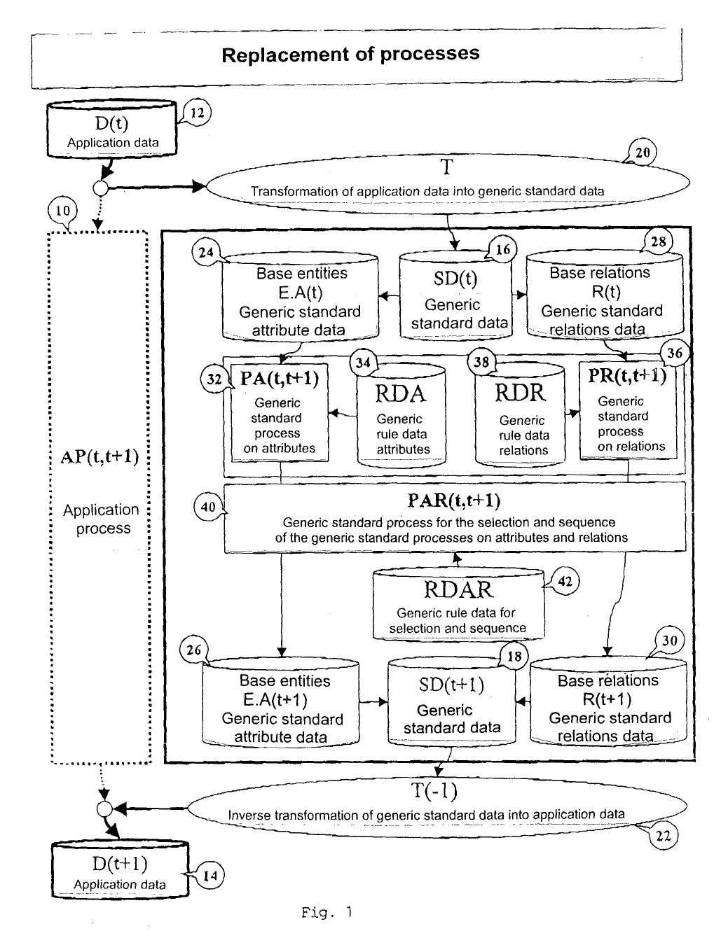

FIG. 1 shows a diagram which schematically represents the method according to the invention;

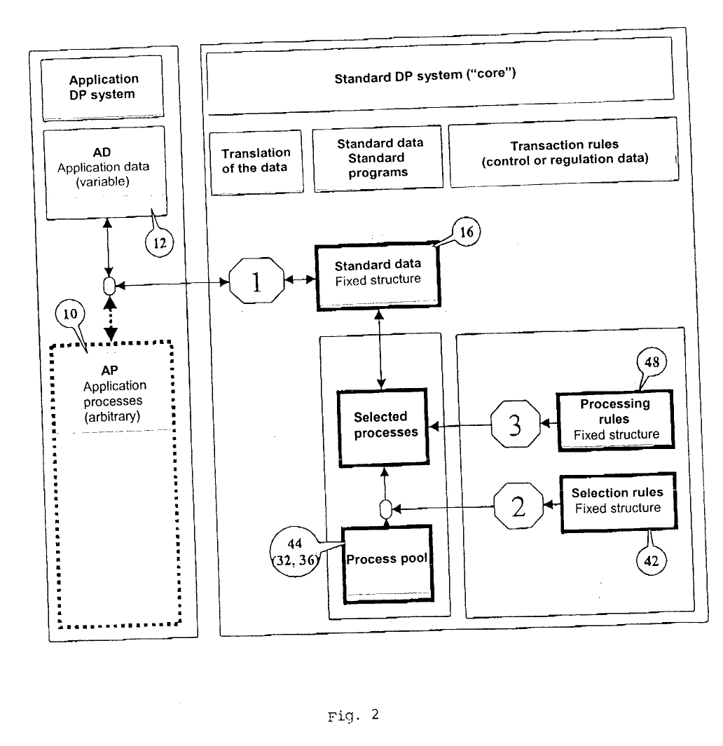

FIG. 2 shows a similar, simplified representation of the method according to the invention shown in FIG. 1;

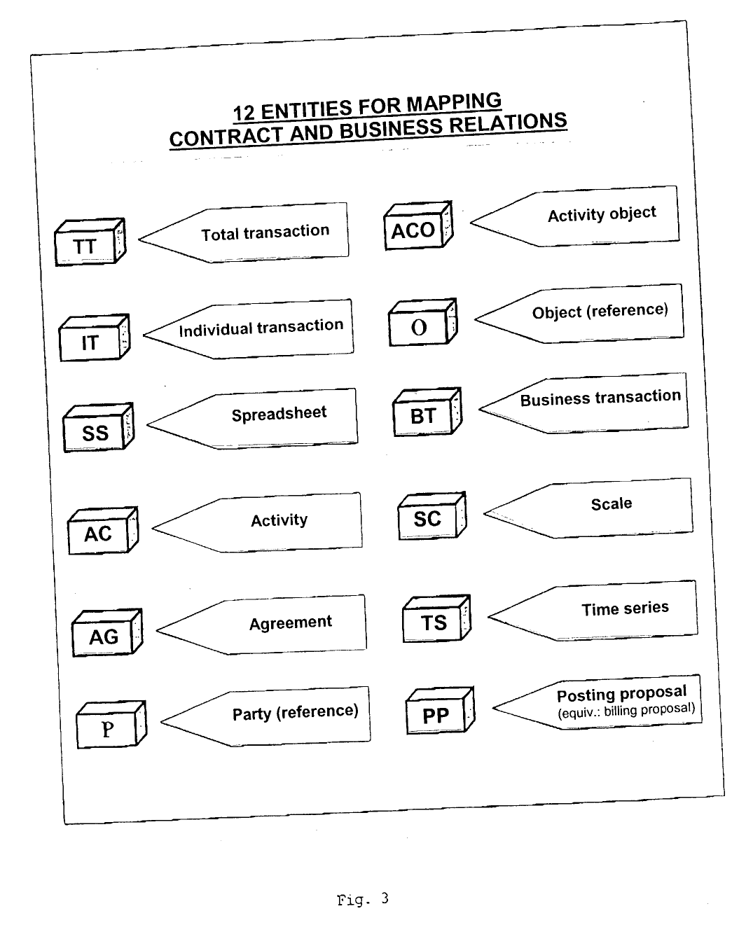

FIG. 3 shows the base entities of the method according to the invention in a preferred embodiment;

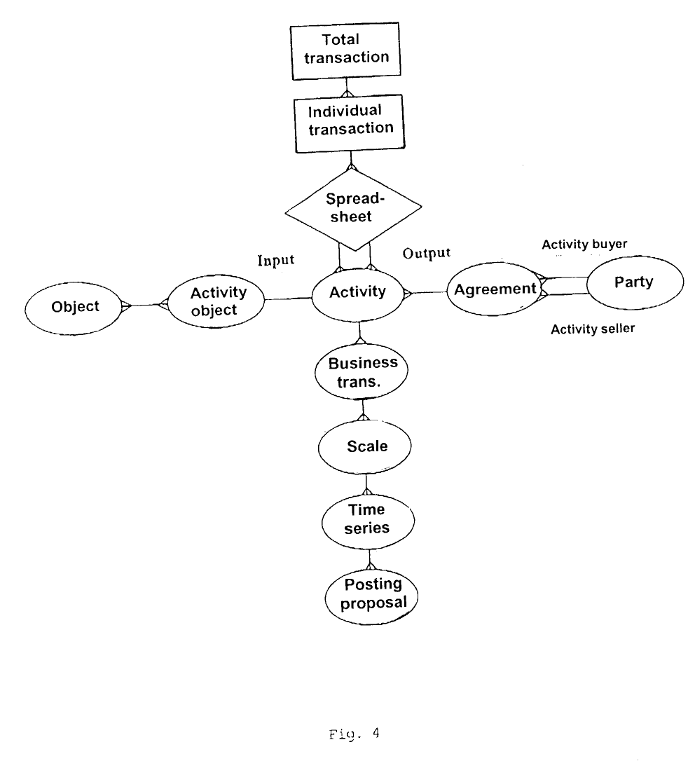

FIG. 4 shows the data model of the method according to the invention in a preferred embodiment;

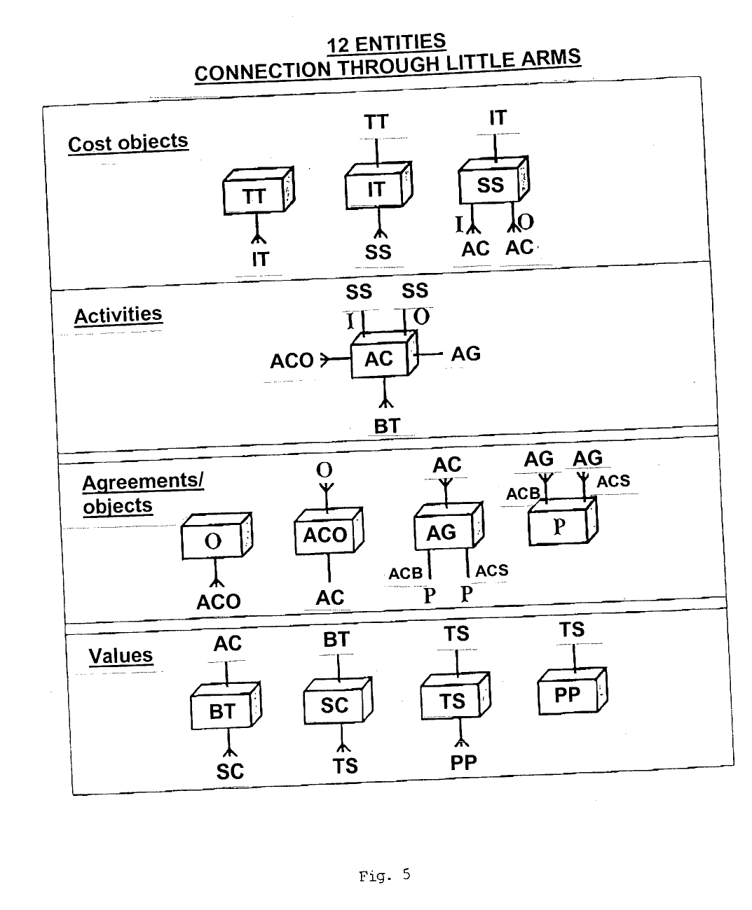

FIG. 5 shows the allowable relations of the data model of FIG. 5; and

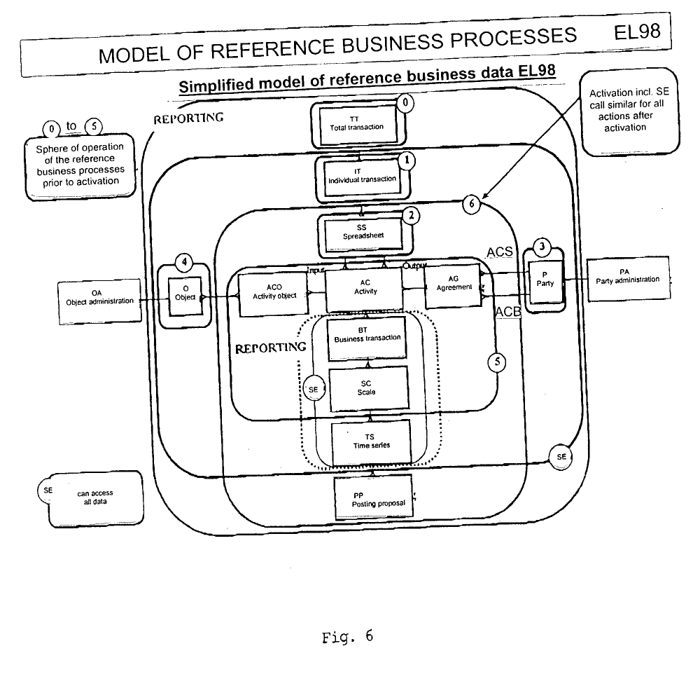

FIG. 6 shows a simplified model for explaining selected standard processes according to a preferred embodiment of the invention.

FIG. 1 shows a diagram for explaining the method according to the invention. On the left side of FIG. 1, a box 10 represents an application process which corresponds to a real flow, input application data 12 being input and output application data 14 being output. Application process 10 can be represented, for example, by the manner in which it changes the state of the application data 12 into the state of the application data 14, i.e. AP={D(t), D(t+1)}. Application processes can be replaced with other processes if they effect the same changes on the data.

According to the diagram of FIG. 1, the application data 12 are transformed into standard data 16 and the processed standard data 18 can be retransformed into the application data 14 as required. To do so, a transformation T, 20, expressed by the equation SD(t)=T(D(t)), and an inverse transformation T⁻¹, 22, expressed by the equation D(t)=T⁻¹(SD(t)), can be used. Transformation and retransformation do not lead to any information losses, i.e. D(t)=T⁻¹ T(D(t)).

The standard data 16, 18 have a fixed, unchangeable structure, i.e. fixed entities or characteristic carriers with fixed attributes and fixed relations between the attributes, the entities corresponding to fixed objects and relations.

The standard data 16, 18 can be broken down into base entities 24, 26, each of which have attributes E.A, and into base entities 28, 30 which exist between attributes and base entities.

For each base entity 24 with its attributes E.A(t), a standard process PA, 32, exists for entering, changing and deleting the characteristic values or values of the attributes E.A. The operating mode of this standard process PA, 32, is based on rules and is determined through regulation data RDA, 34. The regulation data RDA, 34, have a fixed, unchangeable structure

with fixed entities and related attributes as well as with fixed relations between these attributes.

For the base entities R(t), 28, too, a standard process PR, 36, exists for entering, changing and deleting the characteristic values or values of the relations. The operating mode of this standard process PR, 36, is based on rules and is determined through regulation data RDR, 38. Like the regulation data RDA, the regulation data RDR have a fixed, unchangeable structure with fixed entities and related attributes as well as with fixed relations between these attributes.

Therefore, in the system according to the invention, the application data D, 12, are transformed into standard data SD, 16, which in turn are broken down into base entities 24 and base relations 28. All these data and relations have a fixed, unchangeable structure based on fixed, preset attributes. For each base entity and for each base relation, standard processes for entering, changing and deleting the entities or relations exist. These processes also have a fixed structure and are based on rules.

In addition, the invention provides establishing a standard process PAR, 40, which builds up any combination of the standard processes PA and PR, the operating mode of this standard process PAR being based on rules and determined by regulation data RDAR, 42. The standard process PAR, 40, is used for the selection and determination of the sequence of the processes PA and PR for processing the base entities and base relations 24, 28. The regulation data RDAR, 42, have a fixed, preset structure with fixed entities and related attributes as well as with fixed relations between these attributes.

In the method according to the invention, the application data D, 12, are transformed into standard data SD, 16, in such a way that suitable base entities 24 and base relations 28 are selected and the values or characteristic values of their attributes are assigned accordingly. For the mathematical simulation and control of the application process, the regulation data RDAR, 42, RDA, 34, and RDR, 38, are used to establish suitable standard processes PA, 32, and PR, 36, to convert the standard data 16 with their attributes and relations into relevant result standard data 18 with related attributes 26 and relations 30. The resulting standard data SD, 18, can then be retransformed into application data 14 by inverse transformation 22.

FIG. 2 shows another diagram of the same method according to the invention. The method according to the invention, as is illustrated in FIG. 2, consists of three major steps which are referred to as 1, 2 and 3. In step 1, the application data 12 of the application system, which are required in each case, are transformed into the standard data 16 of the standard data processing system according to the invention by allocating the data of the application system with their entities, attributes and characteristic values to the data of the standard data processing system with fixed entities, fixed attributes and variable

characteristic values. In step 2, for the mathematical simulation of the application system 10, the required processes are selected in the correct sequence from a pool of generic standard processes 44 (32, 36 in FIG. 1) using selection rules 42, individual standard processes from the process pool 44 being able to be used repeatedly. The selection rules 42 have a fixed data structure and control the selection from the pool of standard processes 44 only by variable characteristic values of the attributes and relations of these selection rules 42.

In step 3, the operating mode of the selected standard processes 46 is determined on the basis of operation rules 48 (34, 38 in FIG. 1), said operation rules 48 defining what characteristic values the attributes and relations of the standard data 16 should take. The operation rules 48 also have a fixed data structure and are only defined by variable characteristic values of their attributes and relations.

One of the fundamental ideas of the present invention is that all of the base entities, relations between the base entities and standard processes have a fixed data structure.

The data structure is described by the set of all entities with their attributes E.A and by all relations R between these attributes:

D=D(E.A, R)={(entities.attributes, relations)}

where relations (“joins”) on the attribute level=R((E(i).A(j), (E(k),A(l))), i.e. the attribute A(j) from entity E(i) is related to attribute A(l) from entity E(k) or, briefly, R(ij,kl).

The data structure comprises the unchangeable elements of the data. The characteristic values are the actual values of the attributes and/or relations. Only attributes and/or relations have characteristic values. The characteristic values of the data structure are the changeable elements of the data.

The totality of all characteristic values of the data of the system at a particular time t is referred to as the state of the data of the system. The administration of the states of a system allows the complete recording of the histories.

A process describes how a particular state D(t) of the data at the time t can be converted into a state D(t+1) of the data at the time D(t+1).

The operation of the method according to the invention is now described with still further details.

It is the object of an application process AP(t,t+1) to convert application data D from the state D(t) into the state D(t+1), all effects of the process, even those which will occur in future, needing to be taken into account. The time-dependent effects on the attributes and the relations of the application data in particular are also to be taken into account.

An application process AP can be equivalently replaced with the following method:

Transformation T of the processing data (VD) having the state D(t), which are provided for the application process, into the generic standard data SD(t) without loss of information;

Breaking down the generic standard data SD(t) into the generic standard attribute data E.A(t) and into the generic standard relation data R(t);

Calling a generic standard process PAR(t,t+1) which controls in a rules-based manner the selection and sequence of the generic standard processes related to attributes PA(t,t+1) and relations PR(t,t+1). The selection describes the single and repeated selection of processes from a process pool. The process pool contains the following standard processes:

Generic standard processes PA(t,t+1) related to attributes which control in a rules-based manner the conversion of the states of the attributes from E.A(t) into E.A(t+1);

Generic standard processes PR(t,t+1) related to relations which in a rules-base manner control the conversion of the states of the relations from R(t) into R(t+1);

Integration of the generic standard attribute data E.A(t+1) and of the generic standard relation data R(t+1) into the generic standard data SD(t+1);

Inverse transformation T(−1), which is inverse to the transformation T, of the generic standard data SD(t+1) into the result data D(t+1) expected from the application process without loss of information.

The transformation of the data makes the application data readable for the generic standard system. The standard data SD can always be broken down into the entities with their attributes E.A and the relations R between the attributes.

The change of the state of the standard data from SD(t) into SD(t+1) is described as a change of the state of the standard entities from E.A(t) into E.A(t+1) and as a change of the state of the standard relations from R(t) into R(t+1). For each entity and for each relation, the change of state is performed separately.

For each entity E.A(i), i=1,n with its attributes, a generic process PA(i)(t,t+1) exists which can convert in a rules-based manner any state E.A(i)(t) into any other state E.A(i)(t+1).

The rule data RDA for these processes PA(i) have a fixed, generic data structure and variable characteristic values. The actual characteristic values are determined by the simulation of the application process.

For each relation R(j), j=1,m, a generic process PR(j)(t,t+1) exists which can convert in a rules-based manner any state R(j)(t) into any other state R(j)(t+1).

The rule data RDR for these processes PR(j) have a fixed, generic data structure and variable characteristic values. The actual characteristic values are determined by the simulation of the application process.

All generic processes related to attributes PA(t,t+1) and to relations PR(t,t+1) are combined in a pool of generic standard processes.

For each change of state of the standard data from SD(t) into SD(t+1), a sequence of the above-described generic processes PA(t,t+1) and PR(t,t+1) exists so that the changes of state can be generated by a particular selection and sequence of these standard processes PA(t,t+1) and PR(t,t+1) with their respective rule characteristic values RDA(t,t+1) and RDR(t,t+1). [(t,t+1) denotes the time-dependent state of the rules].

For each selection and sequence of generic standard processes PA(t,t+1) and PR(t,t+1), a generic standard process PAR(t,t+1) exists which can generate in a rules-based manner this particular, but also any other desired combination of selections and sequences.

The rule data RDAR(t,t+1) for these processes PAR(t,t+1) have a fixed, generic data structure and variable characteristic values. The actual characteristic values are determined by the simulation of the application process.

In a particularly preferred embodiment of the invention, the data model according to the invention consists of 12 base entities and the standard attributes allocated to them. These 12 entities allow the representation on principle of the finance-effective data of all application systems in the business/commercial field of application.

An overview of the entities is given in FIG. 3.

The respective entities which describe the exchange and production of goods and services are listed in the following Table.

| | |
|---|---|
| TT | The total transaction combines any number of individual |
| Total | transactions to form a larger unit. The total transaction is |
| transaction | used when an interrelation exists between several individual |
| | transactions which is to be made visible in the data model. |
| | The total transaction is the top-most level within the three- |
| | stage mathematical simulation of production (total |
| | transaction, individual transaction, spreadsheet). |
| | Example: |
| | Several leasing individual transactions, financing individual |
| | transactions and purchase individual transactions are to be |
| | evaluable as one total transaction. |
| IT | The individual transaction combines the totality of all |
| Individual | activities used and created—grouped by activity groups |
| transaction | through spreadsheets—by which a production can be |
| | described. |
| | The production is the totality of all operations which leads |
| | to the conversion of the preliminary products/activities into |
| | final products/activities. A production does not need to be |
| | connected with material conversions but it may be e.g. a |
| | financing service as well, material goods (e.g. leasing |
| | objects) and immaterial goods being integrated. As a rule, |
| | a production has several preliminary activities and one or |
| | more final activities. |
| | An individual transaction is the middle level within the |
| | three-stage mathematical simulation of production (total |
| | transaction, individual transaction, spreadsheet). |
| SS | The spreadsheet combines the totality of all activities which |
| Spreadsheet | define as an input or output a production. |
| | The comparison of |
| | the quid pro quo for final products (receipts) and |
| | the quid pro quo for preliminary products (expenditure) |
| | provides the major components of the costing of a |
| | production process or of a final product and is done within |
| | a spreadsheet. |
| | If the costing is used for the determination of the price of |
| | the final product, it is often called preliminary costing. If |
| | the costing is used for the comparison of actual flows of |
| | receipts and expenditure, it is called final costing. |
| | The spreadsheet is the lowest level within the three-stage |
| | mathematical simulation of production (total transaction, |
| | individual transaction, spreadsheet). |
| AC | Activities are not only used (preliminary activities or |
| Activity | preliminary products or input) or created (final activities |
| | or final products or output) in the exchange but also in the |
| | production process. The activities are, therefore, identified |
| | by their position in the production process. Activities can |
| | be used (= preliminary activities/products) or created |
| | (= final activities/products) in the production process. |
| | Accordingly, they are the input or output in the production |
| | process. The quid pro quos connected with the input |
| | activities (= payments) are expenditure and the quid pro |
| | quos connected with the output activities are receipts. The |
| | arrangement of the input and output in the production |
| | process results in the basis for an implicit final costing. |
| | The contents of each activity under contract are described |
| | by an activity type of the same name and a serial |
| | identification number. |
| | The activity is the connecting link between exchange and |
| | production. Produced activities are marketed or procured by |
| | exchange activities. |
| | Under an agreement, several activities can be procured or |
| | sold. As a rule, an activity is goods or a service and the |
| | quid pro quo is money. In financing agreements, activities |
| | and quid pro quos are output by cash flows. |
| | The scope of activity describes those activities, which can |
| | be delivered under a particular type of agreement. As a rule, |
| | one activity is delivered per agreement. In the field of |
| | leasing, for example, several activities such as assignment |
| | for beneficial use, insurances, claims settlement and |
| | maintenance can be delivered under one agreement. |
| AG | Agreements serve for the legal formulation of exchange |
| Agreement | transactions. To the field of leasing, for example, the |
| | following are particularly important: leasing agreement, |
| | loan agreement, sales agreement, commission agreement, |
| | subsidy agreement. |
| | The exchange of activities is performed under agreements. |
| | In the agreements, the parties to the agreement are defined |
| | and the activities and quid pro quos are agreed upon. |
| | The type of agreement results from the type of exchange of |
| | activities (sales agreement, loan agreement, leasing |
| | agreement, etc.) |
| | Preliminary products or activities as well as final products |
| | or activities are procured or soled by exchanging them for |
| | other activities. The exchange of an activity for a quid pro |
| | quo is in each case stipulated by contract. This means that |
| | each exchange of activities is based on particular |
| | agreements. |
| | The agreement must stipulate |
| | the type of agreement; |
| | the names of the parties to the agreement; |
| | the contract position of the respective parties to the |
| | agreement; |
| | the activities or types of activity agreed upon. |
| P | Agreements are concluded between parties to the |
| Parties | agreement. All business partners with whom contractual |
| (to the | relations or contacts have been established are recorded |
| agreement) | in a central register. The involvement in an agreement is |
| | recorded for the respective business partners in a separate |
| | agreement register. |
| | According to their position, the parties to the agreement |
| | involved in the exchange process are referred to as |
| | activity seller (= payee) or |
| | activity buyer (= payor). |
| | Other types of positions (types of roles) are possible. |
| | The roles are given special names; for example, the |
| | purchaser is referred to as the activity buyer in a sales |
| | agreement, the lessee is referred to as the activity buyer |
| | in a leasing agreement or the lessor is referred to as the |
| | activity seller in a leasing agreement. |
| ACO | The final activities created in the production process as well |
| Activity | as the relevant preliminary activities are bound to an |
| object | activity object. In the leasing business, the leasing object is |
| | the activity object (“leased property”). For the leasing |
| | object, the final activity “lease” or “assignment for |
| | beneficial use” is produced. |
| | As a rule, for all activities in the field of leasing business, |
| | only one common activity object exists (i.e. there is a 1:1 |
| | relation to the leasing object). In many cases, however, |
| | activities are output differently on the individual objects. |
| | In these cases, the activity is absolutely necessary for the |
| | allocation between activity and object. |
| O | Objects on which the activities are output are referred to as |
| Object | “object”. |
| | Example: |
| | An agreement including the activity “Procurement of legal |
| | ownership” is executed for a particular motor vehicle |
| | (= object). |
| | Objects are often identical with complex fixed assets |
| | administered in asset accounting. In general, the object term |
| | is, however, defined more comprehensively. |
| | Every object can be composed of any number of items. On |
| | the one hand, items are used for the detailed description. |
| | On the other, the sale and retirement of parts (items) of an |
| | object can also be organized through predefined items. |
| | As a describing element, each item is allocated to exactly |
| | one object. |
| | An object may have any number of items. |
| BT | Business transactions are used for the description of the |
| Business | activities by their finance-effective consequences. |
| transaction | Examples: |
| | The following types of business transactions for the |
| | description of the activity “Assignment for beneficial |
| | use” are possible: |
| | Leasing rate at maturity; |
| | Leasing rate in a calendar-month proration; |
| | Leasing special payments at maturity; |
| | Amount to be redeemed in the event of premature |
| | termination; |
| | Remaining value in the event of scheduled termination. |
| SC | Values provided by the individual business transactions at |
| Scale | different times can be calculated and represented in many |
| | cases when an agreement is concluded (= agreement |
| | consequences). |
| | For the compact representation of even very different flows |
| | using a single basic formula, the scaling technique |
| | including the finance-mathematical elements of present |
| | value, future value, payment, interest and validity period |
| | can be used. As this technique can be used to fully |
| | describe the respective time series values without storing |
| | them physically, scales are also referred to as virtual time |
| | series. |
| | Using the components |
| | scale breakdown, finance-mathematical elements, specific |
| | enhancements, |
| | any sequence of a time series can be described and |
| | calculated compactly. The calculation bases for each value |
| | are known so that intermediate values (e.g. for fractional |
| | validity periods) can also be exactly calculated by different |
| | methods. |
| TS | A time series describes for a particular type of series all |
| Time series | agreement consequences including the time and value. |
| | Unlike virtual time series, time series are stored as |
| | calculation results and are therefore also referred to as |
| | physical time series (in contrast to virtual time series). |
| POSTING | The calculation of physical time series is the prerequisite |
| PROPOSAL | for the preparation of posting proposals. For each posting |
| Posting | proposal, it is noted with an appropriate reference back to |
| proposal | the journal whether this posting proposal has already been |
| | posted. |
| | To decide for which time series posting proposals are to be |
| | created, it is checked for the respective type of business |
| | transactions and the posting variant allocated to that type |
| | whether it is released for posting. In this case, at least one |
| | posting rule is deposited. |
| | For a posting proposal, it is noted |
| | whether it is to be posted, when it is to be posted and where |
| | the posting is to be found in financial accounting. |
| | Similarly, in the field of financial accounting, a reference |
| | back to the underlying agreement, the object, the parties to |
| | the agreement, the agreement conditions, etc. is deposited. |

According to the invention, 11 firmly defined relations, illustrated in FIG. 4, exist between the attributes of the 12 entities. The entities may only be connected along those relations. A shortening of the relations (e.g. by dispensing with the preset paths) is not permissible in most cases, as this reduces analytical potentials. Even if such analytical potentials are not needed in a given case, a shortening should not be used in favour of the uniformity of all applications of the standard system of the invention.

The relations reflect the relationships between the entities of exchange and production. They make up the exchange and production modules of the data model.

The following Table describes permissible relations between the base relations discussed above.

| Entity | Entity | Permissible | Description from the |
|---|---|---|---|
| No. 1 | No. 2 | relation | application point of view |
| TT | IT | 1:e | A total transaction can consist of any |
| | | | number of individual transactions. |
| IT | SS | 1:k | An individual transaction can consist of |
| | | | any number of spreadsheets, i.e. an |
| | | | individual transaction can provide own |
| | | | costings with an own input/output |
| | | | allocation for individual |
| | | | activities produced. |
| SS | AC | 1:n | A spreadsheet can administer any |
| | input | 1:n | number of input activities (= production |
| | output | | factors) for the generation of any |
| | | | number of output activities (= |
| | | | products). (In case of more than one |
| | | | output activity, one speaks of joint |
| | | | production.) The relationship between |
| | | | input and output activity is flexibly |
| | | | controlled through the control data (in |
| | | | particular through a set of equations). |
| | | | These regulations are called, for |
| | | | example, “bills of material” or |
| | | | “formulations” in business economics |
| | | | and are called “input/output functions” |
| | | | or generally “production functions” in |
| | | | economics. |
| AC | AG | m:1 | Under an agreement, any number of |
| | | | activities can be exchanged. Each |
| | | | activity is always allocated to exactly |
| | | | one agreement. |
| AC | BT | 1:g | At the discretion of the user, each |
| | | | activity can be described by any number |
| | | | of business transactions. |
| AC | ACO | 1:t | Any activity can be applied to any |
| | | | number of activity objects or, in other |
| | | | words, any activity can be of benefit to |
| | | | any number of activity objects. |
| | | | (Therefore, activity objects can be also |
| | | | referred to as the activity object.) |
| AG | P | v:1 | Any party can conclude any number of |
| | Activity | | agreements. However, it is always to be |
| | seller | | put down what position that party takes |
| | Activity | | under the agreement. At present, it is |
| | buyer | | provided that a party must always have |
| | Others | | either the position of an activity seller |
| | | | or the position of an activity buyer, but |
| | | | the invention is not restricted hereto. |
| | | | The position and the type of agreement |
| | | | determine the role of the party in this |
| | | | agreement. This issue of position can be |
| | | | further clarified by adding an entity |
| | | | “Role”. As in most cases only two |
| | | | roles (activity seller and activity buyer) |
| | | | are sufficient, the adding of the entity |
| | | | “Role” is dispensed with here. |
| ACO | O | t:o | Any activity object can be physically |
| | | | allocated to one or more objects. Any |
| | | | object can be the object of one or more |
| | | | activity objects. |
| BT | SC | 1:s | Any business transaction can be |
| | | | described in terms of value by any |
| | | | number of scales. |
| SC | TS | 1:z | Any scale can be described in detail in |
| | | | a time series with one or more time |
| | | | series values. |
| TS | PP | 1:b | For any time series, one ore more |
| | | | posting proposals can exist. |

The method according to the invention allows to enter some records for some entities without entering the records of the remaining entities as well, due to the relational relationship between all entities. In this case, the records of the relevant entities are identified by the system as being not yet fully supplied with relations. The relations which have not yet been closed are administered in the form of “free valencies”, i.e. the system knows the relations which are still open. If they are allocated to other records, this can only be done through the existing and the open relations. As soon as the missing data arrive, they are interrelated to each other.

The method according to the invention checks for each individual process whether the status of the system is sufficient for processing, i.e. whether enough entities and relations are available.

Basically, an individual transaction unites all components which describe the economic success (revenues, expenses, liquidity) of the individual transaction. However, cases are possible in which an individual transaction alone does not offer a full overview of the economic success.

### EXAMPLE

In the leasing business, the assignment for beneficial use can be organized by two connected companies.

a) One company is the possessory company. It purchases and finances the leasing object and assigns it to the leasing company for beneficial use. Purchase and financing determine the expense and the assignment to the leasing company for beneficial use determines the revenue. All elements are united under the individual transaction of the possessory company.

b) The leasing company rents the leasing object from the possessory company and assigns it in turn to the lessee (=end customer) for beneficial use. In addition, it pays the agent a commission for the arrangement of the transaction. Renting and commission determine the expense and the leasing rate from leasing determines the revenue. All elements are united under the individual transaction of the leasing company.

The economic success is only defined by both individual transactions together.

As in real life, the concatenation of several individual transactions is through activities. Here, the relevant relations are established in a cross-individual-transaction manner. This can be illustrated with the term “little arm” used in FIG. 5.

The activity assignment for beneficial use which is exchanged between the possessory company and the leasing company is at the possessory company an output of the individual transaction (=of the production of the possessory company). The little arm of output (=a relation of the activity with the relation “output” to a spreadsheet) is connected to the individual transaction of the possessory company. The same assignment of beneficial use is at the leasing company an input of the individual transaction (=of the production of the leasing company). The little arm of input (=a relation of the activity with the relation “input” to a spreadsheet) is connected to the individual transaction of the leasing company.

The concatenation of individual transactions is through the little arms of output and input of the exchanged activity which are connected to the respective individual transactions (spreadsheets).

This method can be used to map indefinitely complex labour-dividing organizations.

In cases in which the standard attributes are not sufficient to map the application-specific attributes, specific dynamic attributes can be added which are allocated to the respective entities of the standard model. The additional attributes are organized through a set of rules which maps the specific attributes in an application-specific manner.

An extension of the data model is not necessary.

The influence of time-dependent changes in the data of the system according to the invention has an effect at several levels:

Scales map changes in values in individual business transactions;

Items map structural changes in individual relations;

Histories map previously valid transactions;

Simulations map transactions which are possible in future.

Scales (and hence time series) map the changes in the values of business transactions. Business transactions (and in particular scales and time series) are the only elements which include value attributes.

The mapping of structural changes requires time-dependent relations. To this end, for each base relation, actual entities were created in which the validity is carried as an attribute. A detailed description is given when an example for application is explained below.

If business orders (=processes) with alterations are performed, the characteristic values (in values and structures) which have already been produced and the characteristic values (in values and structures) to be currently expected are stored in scales and items. The transaction continues to be current. The previously valid scales and items are recorded historically. Storage is done in such a way that the entire individual transaction is identified by a historical record flag prior to alteration.

If future business orders with alterations are to be simulated, the procedure is the same as for an actual alteration. However, the current state continues to be valid and the possible alterations are stored as a new transaction with a simulation indicator.

The technique of history recording and the full administration of the status make all business orders reversible, i.e. all business orders can be reversed with an UNDO function while all changed data are corrected.

All necessary individualizations of the system according to the invention are done through rules. They require the following:

Data (the so-called control data) with their entities, attributes and relations. They are divided by the control of structure- or value-changing orders or standard processes.

Processes (the so-called generic set-of-rules processes) which are able to read out, partly in dependence on conditions such as the status of the system, the rules which are current at a time and to make orders available to the generic standard processes.

Due to the underlying teaching of exchange and production and the fixed, generally valid data model for all commercial-economic applications which can be derived from this teaching, the interfaces, the standard processes and finally also the entities, attributes and relations of the set of rules, that is, the entire set of rules, are fixed and generally valid, irrespective of the type of the individualization demanded. In this context, selected standard processes including their sequence for executing particular orders are referred to as interface groups as will be explained in more detail below.

The interfaces allow the access from outside to the DP system according to the invention. Various types of interfaces can be distinguished by their task and effect:

Interfaces for entering, changing and deleting data;

Structure-processing interfaces (such as creation of individual transactions, spreadsheets, base business transactions);

Value-processing interfaces (such as calculation of business transactions);

Structure- and value-processing interfaces (such as alteration of individual transactions);

Interfaces for reading data.

For all interfaces, internal flows can be controlled in a rules-based manner on the basis of standard processes to execute particular predefined orders.

The following Table shows the concept of the interfaces and its respective function with reference to FIG. 6.

| | Designation | Explanation of the function |
|---|---|---|
| | according to | of the interface or the base entity |
| Type of interface | | to which the interface relates |
| Order: | | Entering, changing and deleting |
| | | the following: |
| Structure-changing | 0 | Total transaction TT |
| | 1 | Individual transaction IT |
| | 2 | Spreadsheet SS |
| | 3 | Party P |
| | 4 | Object O |
| | 5 | Base business transaction |
| Value-changing | SE (set of | Calculations of characteristic |
| | equations) | values of the base entities using |
| | | a set of equations with |
| | | processing data and result data |
| Structure- and | 6 | Actions |
| value-changing | | |
| Order: Reading of data | | |
| | REPORTING | General reading interface |

The interfaces addressable from the outside make available to the outside the activities and services of the system according to the invention for the execution of predefined orders. They internally use a group of generic rule-table-based standard processes.

According to the requirements imposed on a standard system, they can be completely individualized through rule tables, i.e. without programming. Thereby all manipulations of the characteristic values of the (processing and result) data can be performed according to the requirements of the application processes.

The data access (reading and writing) can be a single access or, alternatively, a combination of multiple accesses. If multiple accesses are combined, the data are available in the main memory during prolonged processing chains. For the control data SD (rules), no reloading is required, either. If processing is done by a single access, the data are read and written whenever the interface is called.

The data access layer has two options to store the data (processing data, result data and control data) which are structured and administered according to the principles of a relational database model:

Storing in a relational form according to the data model presented here. This type of data retention requires a relational database management system.

Storing in a condensed and compressed form (BLOB with/without condensing). In this case, the—in all application cases—constant data structure of the system according to the invention is made use of. The data access layer performs a compression with optional packaging and it stores the complete transaction in a record. As an access key, the individual transaction number is used. When data are requested, the record is depackaged again and is decompressed into a relational form before it is processed in the system. In this case, an index-sequential data retention system is sufficient. The data retention in a compressed form allows the administration of very large contract numbers (over 1 million contracts) and a high-performance data processing and compression.

The status administration stores all data on actual work flows. This allows a complete, meaningful history of all entities.

The following is a special embodiment of a transformation between application data and generic standard data for a leasing transaction.

| | Application data | Standard process | Standard data |
|---|---|---|---|
| Application | (I = input/ | Name of | (I = input/ |
| process | O = output) | standard process | O = output) |
| The | The application | A variable | A variable |
| application | data are trans- | sequence of | compilation of |
| process is | formed into | standard | standard data |
| replaced | standard data and | processes is | replaces the |
| with a | are retransformed | used for the | transformed |
| sequence of | from standard | implementation of | application |
| standard | data. | the application | data. |
| processes. | | processes. | |
| Entry of a | INPUT | | |
| leasing | Leasing company | | |
| contract | (name and | | |
| (entry and | account details) | | |
| storage of | Lessee (name and | | |
| all contract- | account details) | | |
| related | Recipient of the | | |
| data) | commission | | |
| | (name and | | |
| | account details) | | |
| | Leasing object/ | | |
| | object | | |
| | EDP system | | |
| | Calculation bases: | | |
| | Purchase cost = | | |
| | DEM 95,000 | | |
| | Remaining | | |
| | value = DEM | | |
| | 40,000 | | |
| | Commission = | | |
| | DEM 5,000 | | |
| | Validity period = | | |
| | 24 months | | |
| | Interest rate = | | |
| | 12% | | |
| | Rental start = | | |
| | Jan. 01, 2000 | | |

Transformation of application data into generic standard
data
Leasing company (name and account details)
Lessee (name and account details)
Recipient of the commission (name and account details)
Leasing object/object
EDP system
Calculation bases:
Purchase cost = DEM 95,000
Remaining value = DEM 40,000
Commission = DEM 5,000
Validity period = 24 months
Interest rate = 12%
Rental start = Jan. 01, 2000

| | |
|---|---|
| Creation of the | INPUT |
| business partners | Business partner |
| (“kgpwrite”) | 1 (name [of |
| Creation (storage) | leasing company] |
| of the business | and account |
| partners | details) |
| Creation (storage) | Business partner |
| of the account | 2 (name [of |
| details of the | lessee] and |
| business partners | account details) |
| Creation of the | Business partner |
| relation between | 3 (name [of |
| business partner | recipient of |
| and account | commission] and |
| details | account details) |
| | OUTPUT |
| | Actual numbers |
| | of the created |
| | business partners |
| | (kgpid = 1,2,3) |
| Creation of the | INPUT |
| object | Name of object |
| (“kobwrite”) | OUTPUT |
| Creation (storage) | Actual number of |
| of the object | the created object |
| Creation of the | (kobid = 1) |
| individual | INPUT |
| transaction | Type of |
| (“egwrite”) | individual trans- |
| Request at the | action (egart) = |
| rule interpreter: | leasing |
| Do the transferred | Producer = |
| business partners | business partner 1 |
| exist? | OUTPUT |
| Is the transferred | Actual numbers |
| type of individual | of the created |
| transaction | individual |
| permissible? | transaction of |
| Is the transferred | the individual |
| producer | transaction type |
| permissible for | “leasing” |
| this type of | (egnr = 1) |
| individual | |
| transaction? | |
| Creation (storage) | |
| of the individual | |
| transaction | |
| Creation of the | INPUT |
| spreadsheet | Type of |
| (“kbwrite”) | individual trans- |
| Request at the | action (egart = |
| rule interpreter: | leasing) and |
| Does the | number of |
| transferred | individual |
| individual | transaction |
| transaction exist? | (egnr = 1) |
| Is the transferred | Type of |
| type of spread- | spreadsheet |
| sheet (kbart) | (kbart) = |
| permissible for | leasing |
| this individual | OUTPUT |
| transaction? | Actual numbers |
| Creation (storage) | of the created |
| of the spreadsheet | spreadsheet of the |
| Creation (storage) | spreadsheet type |
| of the relation | “leasing” |
| between | (kbnr = 1) |
| individual | |
| transaction and | |
| spreadsheet | |
| Creation of the | INPUT |
| base business | Basically, the |
| transactions | following input is |
| (“bgvwrite”) | required for each |
| Request at the | standard process |
| rule interpreter: | of a base business |
| Are the trans- | transaction: |
| ferred types of | Type and number |
| business | of the spreadsheet |
| transactions | to which the |
| permissible for | subsequent base |
| the transferred | business |
| spreadsheet? | transactions are |
| Does the trans- | to be allocated |
| ferred spreadsheet | List of the |
| exist? | respective base |
| Do the transferred | business |
| business partners | transactions |
| exist? | including the |
| Does the trans- | following details: |
| ferred object | Type of business |
| exist? | transaction |
| Use of the rules | Activity seller of |
| for establishing a | the related type |
| business structure | of agreement |
| What types of | Activity buyer of |
| activities (lart) | the related type |
| are to be | of agreement |
| generated for the | Date of the base |
| transferred | business |
| business | transaction |
| transactions? | Value of the |
| What types of | base business |
| agreements (vart) | transaction or |
| are to be | other calculation- |
| generated for | related data |
| the respective | Activity object to |
| activities? | be allocated to |
| What types of | the type of |
| activity object | activity related to |
| (ltart) are to be | the business |
| generated for | transaction |
| the respective | (equivalent to |
| activities? | the type of |
| | activity) |
| In what | Object to be |
| cardinalities | allocated to the |
| business | allocated activity |
| transactions, | object |
| activities and | This default |
| agreements are | group can be |
| interrelated? | repeated n times. |
| Which types of | The base business |
| scales (stvar = | transactions of the |
| single scale or | example require |
| periodic scale) | the following |
| are permissible | actual inputs: |
| for the business | Type of spread- |
| transactions? | sheet (kbart = |
| In what way are | leasing) and |
| the partners of the | actual number of |
| spreadsheet to be | spreadsheet |
| determined or to | (kbnr = 1) |
| be checked? | Related base |
| What is the | business |
| position of the | transactions: |
| respective | Purchase cost |
| activities in | Imputed purchase |
| the production | costs as a part |
| process, i.e. in | of the rent |
| what way are the | assessment basis |
| input/output | Business |
| relations between | partner 1 |
| activity and | Business |
| spreadsheet to | partner 2 |
| be created? | Jan. 01, 2000 |
| Performance of | DEM 95,000 |
| simple value | EDP system |
| completions (e.g. | (kobid = 1) |
| end = start + | Remaining value |
| validity period) | Remaining value |
| Creation (storage) | of the imputed |
| of, and number | purchase costs |
| assignment for | Business |
| Activities | partner 1 |
| Agreements | Business |
| Activity objects | partner 2 |
| Scales | Jan. 01, 2002 |
| Creation (storage) | DEM 40,000 |
| of the relations | EDP system |
| between | (kobid = 1) |
| Agreements and | Leasing rate |
| activity sellers or | Leasing rate |
| activity buyers | Business |
| (= agreement | partner 1 |
| roles) | Business |
| Agreement roles | partner 2 |
| and business | Jan. 01, 2000 |
| partners | (Value remains |
| Agreements and | open and is |
| activities | calculated as |
| Activities and | the result of |
| spreadsheet | activation) |
| taking account of | Interest rate = |
| the position of the | 12% |
| activities in the | Validity period = |
| production | 24 months |
| process (input = | EDP system |
| preliminary | (kobid = 1) |
| activity, output = | Commission |
| final activity) | Commission for |
| Activities and | the arrangement |
| activity object | of the leasing |
| (= object of | individual |
| activity) | transaction |
| Activity object | Business |
| and object | partner 3 |
| Activities and | Business |
| business | partner 1 |
| transactions | Jan. 01, 2000 |
| Business | DEM 5,000 |
| transactions and | EDP system |
| scales | (kobid = 1) |
| | OUTPUT |
| | Actual numbers |
| | of the business |
| | transactions |
| | created for each |
| | type of business |
| | transaction: |
| | for gvart = |
| | purchase cost/ |
| | gvnr = 1 |
| | for gvart = |
| | remaining value/ |
| | gvnr = 1 |
| | for gvart = |
| | leasing rate/ |
| | gvnr = 1 |
| | for gvart = |
| | commission/ |
| | gvnr = 1 |

| | Retransformation of generic standard data into |
|---|---|
| | application data |
| | Status of contract |
| | OUTPUT |
| | Status of |
| | contract = entered |
| Activation of | INPUT |
| a leasing | Current contract |
| contract | number |
| (= costing of | Status of |
| the leasing | contract = entered |
| rate and | |
| calculation | |
| and storage of | |
| all finance- | |
| effective | |
| contract | |
| consequences | |
| including | |
| status | |
| administration | |
| and history | |
| recording) | |
| | Transformation of application data into generic standard |
| | data |
| | Current contract number |
| | Status of contract = entered |

| | |
|---|---|
| Activation of a | INPUT |
| spreadsheet | Type (kbart) and |
| (“activate”) | number (kbnr) of |
| Request at the | the spreadsheet |
| rule interpreter: | to be activated |
| Reading in the | OUTPUT |
| created business | Status of |
| transactions | contract = |
| Generating | activated |
| dependent | Leasing rate = |
| business | DEM 3,192.48 |
| transactions (in | |
| the example: | |
| prepaid expense | |
| of commission) | |
| using the rules of | |
| the business | |
| transaction | |
| creation | |
| Inserting the | |
| values into the | |
| set of equations | |
| Determining the | |
| values in the | |
| set of equations | |
| Transferring the | |
| values of the | |
| results from the | |
| set of equations | |
| Determining the | |
| posting variants | |
| Determining the | |
| posting proposals | |
| for each time | |
| series item | |
| Creation of, | |
| and number | |
| assignment for: | |
| Dependent | |
| business | |
| transactions | |
| Scales for the | |
| dependent | |
| business | |
| transactions | |
| Time series for | |
| the base business | |
| transactions and | |
| for the dependent | |
| business | |
| transactions | |
| Posting proposals | |
| for the base | |
| business | |
| transactions | |
| and for the | |
| dependent | |
| business | |
| transactions | |
| Creation (storage) | |
| of the relations | |
| between: | |
| Activities and | |
| dependent | |
| business | |
| transactions | |
| Dependent | |
| business | |
| transactions | |
| and scales | |
| Scales and | |
| time series | |
| Time series | |
| and posting | |
| proposals | |
| Business | |
| transactions | |
| and scales | |
| Preparation | |
| of a history | |
| Storage of the | |
| individual | |
| transaction | |

Retransformation of generic standard data into
application data
Status of contract = activated
Leasing rate = DEM 3,192.48
OUTPUT
Status of
contract =
activated
Leasing rate =
DEM 3,192.48

1. A method for modelling and for controlling real flows in a data processing system comprising the following process steps:
a) establishing and storing a plurality of preset base entities which correspond to real objects, transactions, relations and the like, the base entities having a fixed, constant data structure with preset attributes;
b) establishing and storing preset, permissible relations each between preset attributes of two selected base entities, the relations having a fixed, constant data structure with preset relation attributes;
c) establishing preset standard processes for a preset number of base entities and base relations so that characteristic values of the attributes of said base entities and said base relations can be automatically manipulated;
d) allocating and storing input-status attribute values, which correspond to characteristic attributes of said real objects, transactions, relations, etc., to attributes of said base entities and of said base relations;
e) establishing, storing and allocating rules for the preset standard processes which define how the standard processes derive output-status attribute values from said input-status attribute values of said base entities and of said base relations, said rules comprising a fixed, constant data structure with preset rule attributes.

2. The method of claim 1 further comprising the process step of allocating dynamic attributes to said base entities.

3. The method of claim 1 or 2, wherein the standard processes required for a definite task are selected from a number of preset standard processes (“pool”) and are arranged.

4. The method of any one of the preceding claims, wherein the base entities, their attributes and input-status attribute values are derived from real parameters of real flows by transformation and are processed in said standard processes and wherein said processed base entities, attributes and their output-status attribute values are retransformed into real objects by appropriate inverse transformations, the transformation T and the inverse transformation T⁻¹ being expressed by the following equation:
x=T∘T⁻¹(x)
wherein x is the quantity to be transformed.

5. The method of claim 3 for modelling and for controlling an application process, in which application data which correspond to real objects, transactions, relations and the like are transformed into standard data of a standard data processing system, which comprise fixed base entities, attributes and relations and variable characteristic values, in which standard data processes system the data of said application process are allocated to said standard data;
a plurality of standard processes are selected in the required sequence from a set of preset standard processes by means of selection rules, the selection rules comprising a fixed data structure and variable characteristic values; and
said standard processes change the characteristic values of the attributes and relations of the standard data on the basis of rules, said rules having a fixed data structure and variable characteristic values and said characteristic values being able to be entered and read out by a user of said application process.

6. The method for modelling and for controlling an application process, in which application data are transformed into standard data, said standard data comprising a fixed, unchangeable structure, i.e. fixed entities with fixed attributes and with fixed relations between the attributes, and the entities, attributes and relations corresponding to the real objects and relations;
said standard data are broken down into base entities and base relations;
for each base entity, a generic standard process is provided for entering, changing and deleting the attribute values of the base entity; and
for each base relation, a generic standard process is provided for entering, changing and deleting the attribute values of the base relation, said standard processes being based on rules.

7. The method of claim 6, in which
each of said base entities and each of said base relations have fixed data structures with fixed attributes and relations between the attributes and variable characteristic values.

8. The method of claim 6 or 7, in which
the standard processes employ regulation data with a fixed data structure with fixed attributes and relations between the attributes and variable characteristic values.

9. The method of any one of the preceding claims, wherein for each base entity a standard process is provided for entering, changing and deleting the attribute values of the base entity.

10. The method of claim 2, wherein for each relation a standard process is provided for entering, changing and deleting the attribute values of the relation.

11. The method of any one of the preceding claims, wherein 12 base entities are established, one base entity, which corresponds to an activity, comprising relations to 4 branches which include the other base entities.

12. The method of claim 11, wherein said 12 base entities linked with each other according to the following scheme: 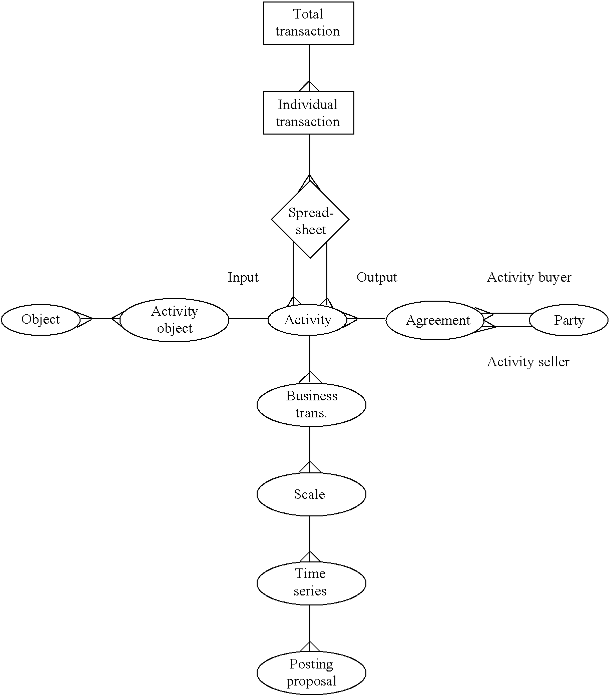
wherein [symbol] is a 1:1 relation, [symbol] is a 1:n relation and [symbol] is an n:m relation.

13. The method of any one of the preceding claims, wherein said attributes and their attribute values or characteristic values are stored in tables.

14. The method of any one of the preceding claims, wherein said base entities include at least the following basic components of real states: object, activity object, activity, agreement, party, transaction, business transaction, scale.

15. The method of any one of the preceding claims, wherein said base entities are selected from the following basic components of real states: object, activity object, activity, agreement, party, total transaction, individual transaction, spreadsheet, business transaction, scale, time series, posting proposal.

16. The method of claim 15, wherein for one or more of the following base entities or groups of base entities, standard processes are defined which are selected from the following:
entering, changing and deleting a total transaction;
entering, changing and deleting an individual transaction;
entering, changing and deleting a spreadsheet;
entering, changing and deleting a party;
entering, changing and deleting an object;
entering, changing and deleting a standard business transaction including an activity object, an activity, an agreement, a business transaction and a scale;
activating a business process including an activity object, an activity, an agreement, a spreadsheet, a business transaction, a scale, a time series and a posting proposal;
calculating output-status attribute values on the basis of input-status attribute values belonging to the following base entities: object, activity object, activity, agreement, party, individual transaction, spreadsheet, business transaction, scale, time series, posting proposals.

17. The method of any one of the preceding claims, wherein at least one base entity is repeatedly processed in a process.

18. The method of any one of the preceding claims, wherein a full description of the real flows or of the application process is derived by entering and storing the input-status attribute values and the output-status attribute values at arbitrary times.

19. A data processing system for accomplishing the method of any one of the preceding claims, comprising input means for inputting input-status attribute values;
first storage means for storing said attribute values in attribute tables related to the base entities;
second storage means for storing preset, permissible relations;
processing means for allocating the relations to the related base entities, said processing means processing the attributes of selected base entities linked by permissible relations and deriving output-status attribute values, in which said rules define how the attributes are to be processed; and
output means for outputting the output-status attribute values.

20. The data processing system of claim 19, comprising transformation means for transforming input parameters of the real flows into input-status attribute values and for retransforming the output-status attribute values into relevant output parameters.

21. A data processing program for accomplishing the method of any one of claims 1-18.
